(19) United States
(12) Patent Application Publication
(10) Pub. No.: US 2009/0147177 A1
(43) Pub. Date: Jun. 11, 2009

(54) MULTI-VISION DISPLAY

(75) Inventors: Kyu-Sung LEE, Suwon-si (KR); Jin-Ho Kwack, Suwon-si (KR); Dong-Won Han, Suwon-si (KR); Min-Chul Suh, Suwon-si (KR)

Correspondence Address: STEIN MCEWEN, LLP, 1400 EYE STREET, NW, SUITE 300, WASHINGTON, DC, 20005, US

(73) Assignee: Samsung Mobile Display Co., Ltd., Suwon-si (KR)

(21) Appl. No.: 12/328,196

(22) Filed: Dec. 4, 2008

(30) Foreign Application Priority Data
Dec. 6, 2007 (KR) 2007-126203

(51) Int. Cl. G02F 1/1335; G02F 1/133

(52) U.S. Cl. 349/61; 349/73

(57) ABSTRACT

A multi-vision display including first and second display panels having edges that at least partially overlap, the first and second display panels each including pixel regions, non-pixel regions disposed around the pixel regions, and driving circuits mounted on the non-pixel regions, to supply driving signals to the pixel regions. The driving circuits are located on edges of the first and second display panels that face the overlapped edges.

### CROSS-REFERENCE TO RELATED APPLICATIONS

This application claims the benefit of Korean Application No. 2007-126203, filed Dec. 6, 2007, in the Korean Intellectual Property Office, the disclosure of which is incorporated herein by reference.

### BACKGROUND OF THE INVENTION

1. Field of the Invention

Aspects of the present invention relate to a multi-vision display, and more particularly, to a multi-vision display including at least two flat display panels.

2. Description of the Related Art

Recently, research into flat panel displays, such as a liquid crystal display (LCD), a plasma display panel (PDP), a field emission display (FED), an organic light emitting display (OLED), etc., has been actively conducted. Flat panel displays, which are light and small, have been applied to various portable electronic devices, such as a mobile phone, a PDA, and a notebook computer.

As techniques for producing flat panel displays have improved, flat panel displays have been used in a greater number of applications. In particular, there is a need for large-sized flat panel displays for use in a variety of large-scale applications. However, at the present time, there is a limit as to how large flat panel displays can be manufactured.

Therefore, for extremely large applications, a multi-vision display has been developed. The multi-vision display is a large scale display device that includes a plurality of display panels, which are incorporated into a single screen. Such a multi-vision display displays different images on each unit display panel, or divides one image into units, and displays each unit on a different display panel.

The display panels are incorporated into the screen in a tiled manner, by bonding the plurality of display panels together. However, such a tiled screen has a disadvantage in that boundary regions between the display panels are visible, due to non-pixel regions in edge regions of the respective display panels. In particular, wires that supply power and/or driving signals to the display panels, are disposed in the boundary regions. The wires disposed in the boundary regions reflect light, or seem to be dark lines, which increases the visibility of the boundary regions.

### SUMMARY OF THE INVENTION

Aspects of the present invention provide a multi-vision display including at least two flat display panels, and which reduces the appearance of boundary regions between the display panels.

Aspects of the present invention provide a multi-vision display including first and second display panels that are overlapped at edge regions thereof. The first and second display panels include pixel regions, non-pixel regions that surround the pixel regions, and driving circuits mounted on the non-pixel regions, to supply driving signals to the pixel regions. The driving circuits are located at edge regions of the display panels that face the overlapped edge regions.

According to aspects of the present invention, the non-pixel regions include: a first non-pixel region, where the display panels are overlapped; a second non-pixel region that faces the first non-pixel region, and has the driver circuit mounted therein; and third and fourth non-pixel regions that face each other, and extend between the first and second non-pixel regions.

According to aspects of the present invention, the first and second display panels each further include wires to couple the driver circuits to the pixel regions. The wires extend from the pixel regions to the second non-pixel region, through at least one of the third and fourth non-pixel regions.

According to aspects of the present invention, the first and second display panels each further include pad units formed on at least one edge of the second non-pixel region, and at least one wire to couple the pad units to the pixel regions, which extends through at least one of the third and fourth non-pixel regions.

According to aspects of the present invention, the first non-pixel regions of the first and second display panels are overlapped, and wires are disposed in the third and/or fourth non-pixel regions of the first and second display panels, to supply power and/or driving signals to the pixel regions.

According to aspects of the present invention, the multi-vision display further includes an intermediate signal controller to divide a video signal between the first and second display panels, such that the first and second display panels each display portions of an image that corresponds to the video signal.

According to aspects of the present invention, the first and second display panels are organic light emitting display panels having a plurality of pixels that include organic light emitting diodes. The first and second display panels each include a substrate, an organic light emitting unit including the organic light emitting diodes, formed on one surface of the substrate, and a thin-film type sealing film to seal the organic light emitting unit. The substrate has a thickness of 0.05 mm to 0.5 mm. The thin-film type sealing film is a stacked film including at least one barrier layer and at least one polymer layer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent, and more readily appreciated from, the following description of the exemplary embodiments, taken in conjunction with the accompanying drawings, of which:

FIG. 1 is a plane view of a multi-vision display panel, according to an exemplary embodiment of the present invention;

FIG. 2 is a plane view of a multi-vision display panel, according to another exemplary embodiment of the present invention;

FIG. 3 is a side view of a multi-vision display panel, according to an exemplary embodiment of the present invention;

FIG. 4 is a cross-sectional view of a multi-vision display panel, according to an exemplary embodiment of the present invention;

FIG. 5 is a cross-sectional view of a thin-film type sealing film of FIG. 4; and

FIG. 6 is a construction block view of an exemplary multi-vision display.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

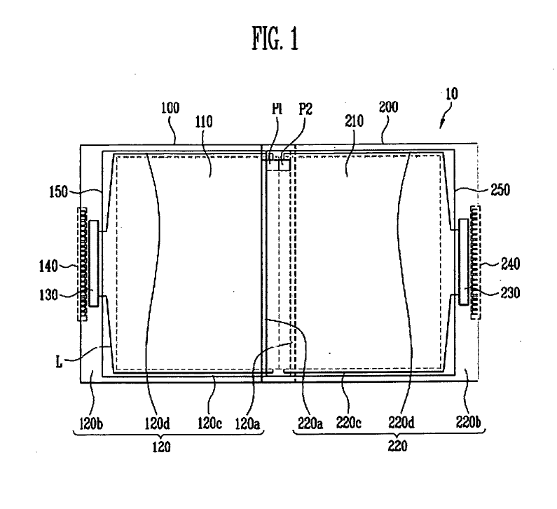

FIG. 1 is a plane view of a multi-vision display panel 10, according to an exemplary embodiment of the present invention. Referring to FIG. 1, the multi-vision display panel 10 includes first and second display panels 100 and 200 that are partially overlapped with each other. The first and second display panels 100 and 200 are generally flat panel display panels.

The first and second display panels 100 and 200 include: pixel regions 110 and 210; driving circuits 130 and 230 to supply driving signals to the pixel regions 110 and 210; and pad units 140 and 240 to supply control signals to the driving circuits 130 and 230. The pixel regions 110 and 210 include a plurality of pixels P arranged in a matrix. Although pixel regions of each display panel 100 and 200 are provided with a plurality of pixels, only two pixels, in regions where the display panels are adjacent, are described, for convenience. The pixels P are supplied with power and the driving signals from the driving circuits 130 and 230. The pixels P emit different amounts of light, according to the supplied power and the driving signals, to display an image.

The driving circuits 130 and 230 are mounted on non-pixel regions 120 and 220, which are peripheral to the pixel regions 110 and 210. The driving circuits 130 and 230 generate the driving signals, according to the control signals transferred from the pad units 140 and 240.

In the multi-vision display panel 10, the first and second display panels 100 and 200 are partially overlapped, such that pixels P1 and P2 are adjacent to each other. For example, the first and second display panels 100 and 200 may be disposed, such that first non-pixel regions 120a and 220a, of the pixel regions 110 and 210, are overlapped.

The driving circuits 130 and 230 are mounted on the respective display panels 100 and 200 in second non-pixel regions 120b and 220b, which face the first non-pixel regions 120a and 220. This is to prevent wires L, which couple the driving circuits 130 and 230 to the pixel regions 110 and 210, from being disposed in regions where the display panels 100 and 200 are overlapped. The wires L supply power and/or driving signals from the driving circuits 130 and 230, to the pixel regions 110 and 210. For example, the wires L may correspond to scan lines, and can transfer scan signals.

The wires L may be directly coupled to the pixel regions 110 and 210, through the second non-pixel regions 120b and 220b. Otherwise, the wires L may be coupled to the pixel regions 110 and 210, through third non-pixel regions 120c and 220c and/or fourth non-pixel regions 120d and 220d, which extend between the first and second non-pixel regions 120a, 220a, 120b, and 220b, and face each other, at edges of the pixel regions 110 and 210. For example, when the first pixel regions 120a and 220a are overlapped, the wires L may extend through the second non-pixel regions 120b and 220b, and the fourth non-pixel regions 120d and 220d, or through the third non-pixel regions 120c and 220c, and the fourth non-pixel regions 120d and 220d. Although FIG. 1 shows only the wires L, which couple the driving circuits 130 and 230 to the pixel regions 110 and 210, wires (not shown) may also be formed between the pad unit 140 and 240 and the pixel regions 110 and 210.

FIG. 2 is a plane view of a multi-vision display panel 101, according to another exemplary embodiment of the present invention. In FIG. 2, similar components as shown in FIG. 1 are given with the same reference numerals, and a detailed description thereof is omitted. Referring to FIG. 2, the display panels 100 and 200 include wires L′ that couple pad units 140 and 240 to pixel regions 110 and 210.

The wires L′ supplying power and/or driving signals from the pad units 140 and 240 to pixels P1 and P2. The wires L′ may transfer power supplied from a power supply unit mounted on a flexible printed circuit board (not shown), etc., through the pad units 140 and 240, to the pixel regions 110 and 210.

If the driving circuits 130 and 230 are not mounted on the display panels 100 and 200, the wires L′ may transfer externally received scan signals and/or data signals to the pad units 140 and 240. The wires L′ are not disposed in first non-pixel regions 120a and 220a, where the display panels 100 and 200 are overlapped.

The pad units 140 and 240 can be formed at edges of the second to fourth non-pixel regions 120b, 120c, 120d, 220b, 220c, and 220d. The wires L′ are coupled between the pad units 140 and 240 and the pixel regions 110 and 210, though at least one of the second to fourth non-pixel regions 120b, 120c, 120d, 220b, 220c, and 220d.

For example, the pad units 140 and 240 may be formed in the edge of the second non-pixel regions 120b and 220b, adjacent to the driving circuits 130 and 230. The wires L′ may be directly coupled to the pixel regions 110 and 210, through the second non-pixel regions 120b and 220b, or may be coupled to the pixel regions 110 and 210, through the third and/or fourth non-pixel regions 120c 120d, 220c, and 220d.

In the multi-vision display panels 10 and 101, the first and second display panels 100 and 200 are partially overlapped, making it possible to minimize the separation of an image displayed on the display panels 100 and 200. The driving circuits 130 and 230 of the respective display panels 100 and 200 are located in the fourth non-pixel regions 120d and 220d. The wires L and L′ are not located in areas where the pixel regions 110 and 210 overlap, to minimize the appearance of a boundary between the display panels 100 and 200.

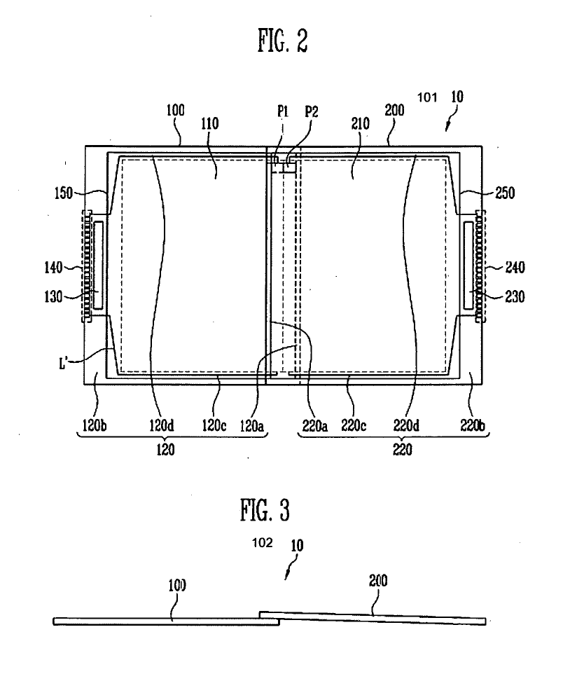

FIG. 3 is a side view of a multi-vision display panel 102. For convenience, FIG. 3 illustrates only the overlap of first and second display panels 100 and 200. Referring to FIG. 3, the second display panel 200 is slanted with respect to the first display panel 100. In other words, a plane defined by the surface of the first display panel 100, is not parallel to a plane defined by the surface of the second display panel 200.

In order to stabilize the coupling between the first and second display panels 100 and 200, the portions thereof may be joined by a transparent adhesive (not shown), or a connecting member (not shown), etc. In order to accurately display an image in the overlapped portion, and to maintain a suitable viewing angle, a step formed where the first and second display panels 100 and 200 are overlapped, should be small. In other words, the first and second display panels 100 and 200 should be thin. For example, the first and second display panels 100 and 200 may have a thickness of 1.5 mm, or less.

When the thickness of the first and second display panels 100 and 200 is small, it is relatively easy to locate one display panel in front of the other. For example, one of the display panels 100 and 200 can be slid or folded together, so as to completely overlap. If the two display panels 100 and 200 are completely overlapped, the space occupied by the multi-vision display panel 10 is reduced. This configuration is useful when the multi-vision display panel 102 is not in use, or when an image is displayed on only one of the display panels 100 and 200. Therefore, the first and second display panels 100 and 200 are generally relatively thin.

An organic light emitting display panel, which uses organic light emitting diodes that are self-emission elements, does not require a separate light source. Therefore, organic light emitting display panels are relatively thin, have excellent color reproduction, and have an excellent viewing angle. Therefore, organic light emitting display panels are suited for use as the multi-vision display panels, according to aspects of the present invention. Organic light emitting display panels include sealing members (150 and 250 in FIG. 1) to protect pixel regions that include organic light emitting diodes, from moisture, etc.

The sealing members 150 and 250 can be a sealing substrate, a sealing film, etc. The sealing film may be a thin-film type, as compared to a sealing substrate, such as glass, etc. Therefore, according to aspects of the present invention, a thin-film type sealing film is generally used.

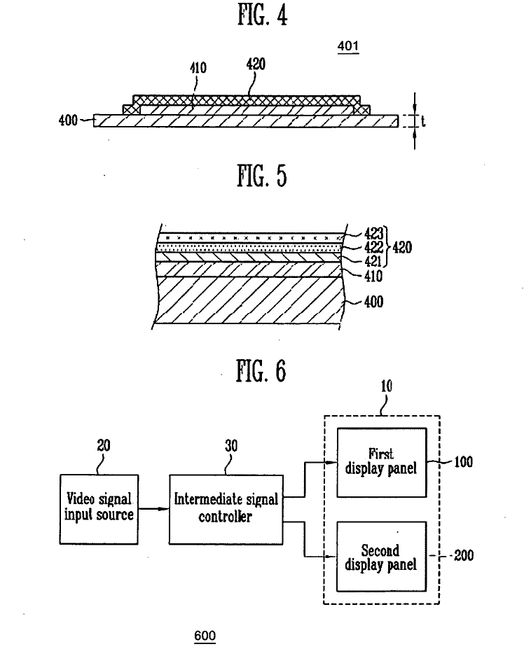

FIG. 4 is a cross-sectional view of an organic light emitting display panel 401. FIG. 5 is a partial cross-sectional view of the panel 401 of FIG. 4. Referring to FIGS. 4 and 5, the display panel 401 includes a substrate 400, an organic light emitting unit 410 formed on one surface of the substrate 400, and a thin-film type sealing film 420 to seal the organic light emitting unit 410.

The substrate 400 is formed of a transparent glass, etc., in order to prevent images displayed on an adjacent overlapped panel from being blocked or distorted. However, when a thickness t of the substrate 400 is large, distortions can occur, so the substrate 400 generally has a relatively small thickness. To this end, the thickness t of the substrate 400 is reduced, by wet etching, sand blasting, etc. For example, the thickness t of the substrate 400 may be within a range of about 0.05 mm to about 0.5 mm.

The organic light emitting unit 410 has a plurality of pixels (not shown) including organic light emitting diodes. The thin-film type sealing film 420 includes an inorganic thin-film layer, which is deposited by CVD, sputtering, etc., and may further include a polymer layer and/or a resin layer, etc. For example, in the thin-film type sealing film 420 a polymer layer 422 can be provided between two barrier layers 421 and 423.

The barrier layers 421 and 423 may be formed of a transparent barrier material, but are not limited thereto. For example, the barrier layers 421 and 423 can be formed of a metal oxide, a metal nitride, a metal carbide, a metal oxynitride, or a combination thereof. As the metal oxide, silica, alumina, titania, indium oxide, tin oxide, indium tin oxide, and a compound thereof may be used. As the metal nitride, aluminium nitride, silicon nitride, or a combination thereof may be used. As the metal carbide, silicon carbide may be used, and as the metal oxynitride, silicon oxynitride may be used.

The barrier layers 421 and 423 may be formed of a material, such as silicon, that is capable of blocking the infiltration of moisture and/or oxygen. The barrier layers 421 and 423 may be formed as a deposited film. However, defects such as voids may occur in the barrier layers 421 and 423, during the deposition of the barrier layers 421 and 423, and such defects may increase in size over time. Therefore, in order to prevent such defects from growing, the polymer layer 422 is further provided, in addition to the barrier layers 421 and 423.

As the polymer layer 422, an organic polymer, an inorganic polymer, an organometallic polymer, a hybride organic/inorganic polymer, etc., may be used. However, when the polymer layer 422 is formed of an organic film, the polymer layer 422 should not be exposed to the external environment. In other words, if an organic film is used, the organic film should be covered with the barrier layer 423.

The thin-film type sealing film 420 may have various other configurations, besides those described above. The thickness of the organic light emitting display panel 401 can be reduced, by reducing the substrate thickness t, and sealing the organic light emitting unit 410 with the thin-film type sealing film 420. Therefore, in implementing the first and second display panels 100 and 200, as shown in FIGS. 1 and 2, the stepped overlap between the display panels 100 and 200 can be lessened.

FIG. 6 is a construction block view of an exemplary multi-vision display 600 that is applicable to the multi-vision display panels of FIGS. 1, 2, and 3. Referring to FIG. 6, the multi-vision display 600 includes a video signal input source 20, an intermediate signal controller 30, and a multi-vision display panel 10. The video signal input source 20 may be a video player, a set top box (STB), a digital video disk (DVD) player, etc. Video signals input from the video signal input source 20 are supplied to the intermediate signal controller 30.

The intermediate signal controller 30 properly distributes the video signals to first and second display panels 100 and 200 of the multi-vision display panel 10. While two panels are shown for convenience, any number of display panels can be used. The first and second display panels 100 and 200 can display a single image corresponding to the video signals supplied from the intermediate signal controller 30.

The multi-vision display panels of the present invention are not always limited to displaying one image. For example, the first and/or second display panels 100 and 200 may display different images, or only one of the display panels 100 and 200 may display an image.

According to aspects of the present invention, a multi-vision display can include at least two display panels, which are at least partially overlapped, making it possible to minimize the disruption of an image at the overlap. Driving circuits of the respective display panels are located in non-display regions of the panels, which face the region where the display panels are overlapped. Wires are not located in the overlap region, making it possible to minimize the appearance of a boundary between the display panels. Also, the substrate thickness of the respective display panels is reduced, by using a thin-film type sealing film. Thereby, a step formed at the overlap region, is reduced.

Although exemplary few embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A multi-vision display comprising:
first and second display panels comprising pixel regions, non-pixel regions disposed around the pixel regions, and driving circuits mounted on the non-pixel regions, to supply driving signals to the pixel regions, wherein,
first edges of the first and second display panels overlap each other, and
the driving circuits are disposed on second edges of the first and second display panels, which face the first edges.

2. The multi-vision display as claimed in claim 1, wherein the non-pixel regions comprise:
first non-pixel regions which form the first edges;
second non-pixel regions which form the second edges; and
third and fourth non-pixel regions that face each other, and form third and fourth edges of each of the first and second display panels.

3. The multi-vision display as claimed in claim 2, wherein the first and second display panels further comprise wires to couple the driver circuits to the pixel regions, which extend along at least one of the third and fourth non-pixel regions.

4. The multi-vision display as claimed in claim 2, wherein the first and second display panels further comprise:
pad units formed on the second non-pixel regions, at the second edges; and
wires to couple the pad units to the pixel regions, which extend along at least one of the third and fourth non-pixel regions.

5. The multi-vision display as claimed in claim 1, wherein:
the non-pixel regions comprise,
first non-pixel regions that form the first edges,
second non-pixel regions that form the second edges, and
third and fourth non-pixel regions that face each other, and form third and fourth edges of each of the first and second display panels; and
the multi-vision display further comprises wires to supply power and/or driving signals to the pixel regions, which extend along the third or fourth non-pixel regions.

6. The multi-vision display as claimed in claim 1, further comprising an intermediate signal controller to divide a video signal between the first and second display panels, such that the first and second display panels each display a portion of an image that corresponds to the video signal.

7. The multi-vision display as claimed in claim 1, wherein the first and second display panels are organic light emitting display panels comprising a plurality of organic light emitting diodes.

8. The multi-vision display as claimed in claim 7, wherein the first and second display panels each comprise:
a substrate;
an organic light emitting unit comprising the organic light emitting diodes, formed on one surface of the substrate; and
a thin-film type sealing film to seal the organic light emitting unit.

9. The multi-vision display as claimed in claim 8, wherein the substrate has a thickness of about 0.05 mm to 0.5 mm.

10. The multi-vision display as claimed in claim 8, wherein the thin-film type sealing film is a stacked film comprising at least one barrier layer and at least one polymer layer.

11. A multi-vision display comprising first and second display panels, each of the first and second display panels comprising:
a pixel region;
first, second, third, and fourth non-pixel regions disposed around the pixel region;
a driving circuit to supply driving signals to the pixel region, mounted on the second non-pixel region, which faces the first non-pixel region; and
at least one wire extending between from the driving circuit, along the third non-pixel region, to the pixel region, wherein,
the first non-pixel region of the first display panel overlaps the first non-pixel region of the second display panel, and
the third and fourth non-pixel regions face each other.

12. The multi-vision display of claim 11, wherein the first and second display panels are moveable, such that the first and second display panels can be completely overlapped.

13. The multi-vision display of claim 11, wherein the wires are not disposed in the first non-pixel regions.

14. The multi-vision display of claim 11, wherein the first and second display panels are organic light emitting displays.

15. The multi-vision display of claim 11, wherein a plane defined by a display surface of the first display panel, is not parallel to a plane defined by a display surface of the second display panel.

16. The multi-vision display of claim 11, wherein pixels of the first display panel, which are adjacent to the first non-display region thereof, are adjacent to pixels of the second display panel, which are adjacent to the first non-display region thereof.

17. The multi-vision display of claim 11, wherein the first and second display panels comprise substrates that have a thickness of between about 0.05 mm to 0.5 mm.
